(19) United States
(12) Patent Application Publication
(10) Pub. No.: US 2016/0360734 A1
(43) Pub. Date: Dec. 15, 2016

(54) Frame Storage Box for Honeycomb

(71) Applicants: Joseph D. Forte, Nashville, TN (US); William D. Forte, Nashville, TN (US)

(72) Inventors: Joseph D. Forte, Nashville, TN (US); William D. Forte, Nashville, TN (US)

(21) Appl. No.: 15/178,477

(22) Filed: Jun. 9, 2016

Related U.S. Application Data
(60) Provisional application No. 62/230,581, filed on Jun. 11, 2015.

(51) Int. Cl. A01K 47/02

(52) U.S. Cl. CPC A01K 47/02

(57) ABSTRACT

Through the years handling/transporting framed honey bee combs has been for the most part leaving them in the hive box that was taken off the main colony. This method is used by commercial beekeepers that hive hundreds maybe thousands of colonies. Their object is to produce large quantities of bulk honey for mass distribution. The vast majority of beekeepers around the world are backyard hobbyist that maintain a small number of colonies. This invention is targeted for that group. This invention would benefit beekeeping hobbist to maintain a uniform organized safe and clean method of storing honey frames throughout their beekeeping operation.

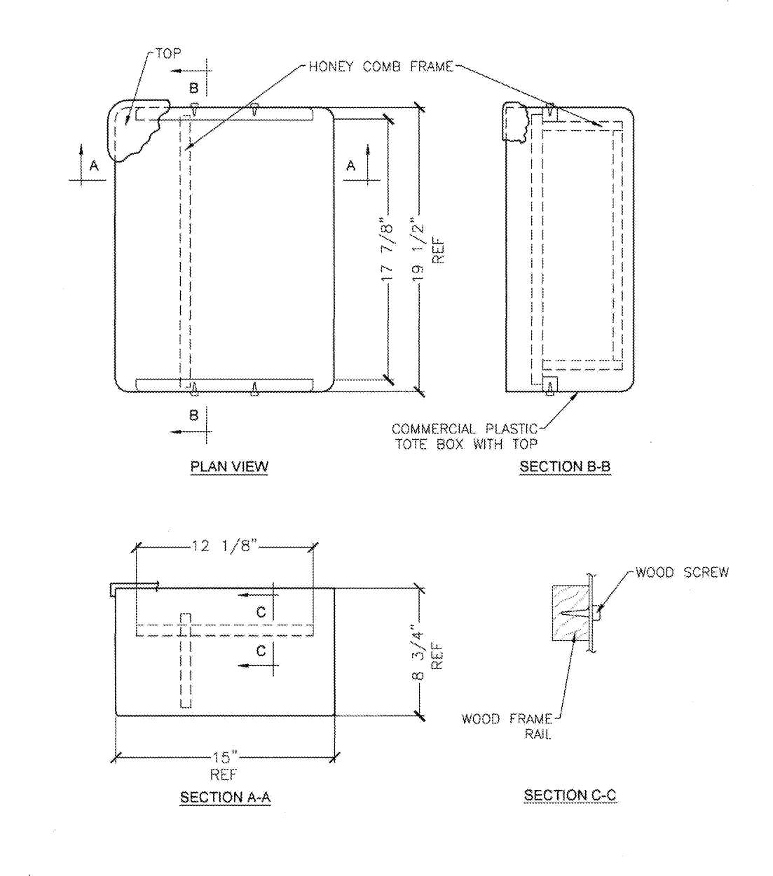

### CROSS REFERENCE TO RELATED APPLICATION

Provisional Patent Application No. 62/230,581 dated Jun. 11, 2015

### BACKGROUND OF INVENTION

There is no comparible container on the market to organize and store honey frames. The container is completely enclosed keeping out wax moths and other pests that could destroy the comb. It also prevents a huge mess at the time of extraction. It is light weight and easy cleanup with a garden hose.

### BRIEF SUMMARY

The container provides a place to store honey frames in each of the four processes where the frames must must be handled.

### BRIEF DESCRIPTION OF THE DRAWING

The drawing shows a commercially purchased plastic container with a top. It shows fabricated wood rails that are attached with screws on each end that supports standard honey frames that are commonly used in the beekeeping business. The height and width of the box must be suitable to contain the dimensions of the honey frame.

### DETAILED DESCRIPTION OF THE INVENTION

Honey frames are normally bought as components that are assembled by the user. The components are the prefabricated parts of the rectangular wooden frame and a wax sheet of “foundation” to be mounted in the frame that the bees build on to produce a honey comb. After this assembly the frames would be stored in the frame storage box. This would be the first process where the box would be used. Second would be transporting the frames to the hive location. The third would be collecting the frames full of honey, brushing off the bees, place the top on and transport to the honey extractor. Normally this would be done by transporting the hive body full of honey to the place of extraction. With honey dripping from the comb and stragglers bees on the comb plus other material from the hive creates a major clean-up problem. The forth would he storing the frames of comb that have been extracted for storage until the next use.

1. The claim for this invention is that no other closed container exists that is suitable to store a standard. Langstrom honey frames supported by rails that organize the frames through the entire process of frame handling in the beekeeping business.
